(19) United States
(12) Patent Application Publication
(10) Pub. No.: US 2008/0076374 A1
(43) Pub. Date: Mar. 27, 2008

(54) System and method for filtering of angle modulated signals

(76) Inventor: Avraham Grenader, Hadera (IL)

Correspondence Address: AVRAHAM GRENADER, SHALOM TSAIRI ST., 4, HADERA, 38262, omitted

(21) Appl. No.: 11/901,536

(22) Filed: Sep. 19, 2007

Related U.S. Application Data
(60) Provisional application No. 60/846,580, filed on Sep. 25, 2006.

(51) Int. Cl. H04B 1/10; H04L 27/156

(52) U.S. Cl. 455/307; 375/334

(57) ABSTRACT

Method for iterative multi-stage adaptive filtering of angle modulated passband and baseband signals based on varying of current value of instantaneous frequency to reach powerful noise canceling, by means of calculation and estimation of current value of instantaneous frequency by using demodulation and reversed modulation calculation process to estimate and calculate the current value of the said estimated instantaneous frequency, and applying narrower sub-bandwidth adaptive filtering, which follows in real-time after the said estimated instantaneous frequency, where the said instantaneous frequency is the central filtering frequency of the said sub-bandwidth filter.

### CROSS-REFERENCE TO RELATED APPLICATIONS

This application is entitled to the benefit of Provisional Patent Application Ser. No. 60/846,580 filed Sep. 25, 2006.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

The present invention relates to a method and structure of adaptive real-time and multi-stage pass-band filtering of angle modulated passband and baseband signals of analog and digital demodulators and receivers and more particularly, for adaptive filtering of any angle modulated signal, which was created by any type of angle modulation of instantaneous frequency of the modulated signal. For instance, the present invention relates for FM and PM demodulation where some baseband signal is modulated by using instantaneous frequency varying to create passband modulated signal. For many types of analog and digital modulation, the instantaneous frequency based modulated signal is passband modulation of any type of baseband modulating signals, which modulate carrier of a passband signal by varying current value of instantaneous frequency.

Furthermore, the present invention relates also for any type of digital baseband (I-Q) frequency-shift keying (FSK) or phase-shift keying (PSK) based angle modulations, which are created also by instantaneous frequency variation within its baseband bandwidth to modulate discrete digital pulses and therefore, it is also covered by the present invention. Thus, the term “passband” bandwidth of analog angle modulated signals includes also the case of “baseband” bandwidth for digital angle modulated and coupled amplitude-angle modulated signals.

A technique employed in telecommunications transmission systems whereby an electromagnetic signal (the modulating signal) is encoded into one or more of the characteristics of another signal (the carrier modulated signal), whose properties are matched to the characteristics of the medium over which it is to be transmitted. The encoding preserves the original modulating signal in that it can be recovered from the modulated signal at the receiver by the process of demodulation. In the case of instantaneous frequency based modulation, the demodulator performs reverse calculation and estimation of initial modulating signal, which has directly correlation with instantaneous frequency variation within modulated passband bandwidth spectrum, and therefore, which directly characterizes initial modulating signal.

In most applications of modulation the carrier modulated signal is a sine wave, which is completely characterized by its amplitude, its frequency, and its phase relative to some point in time. Modulating the carrier then amounts to varying one or more of these parameters in direct proportion to the parameters of the modulating signal.

The main purpose of modulation is to overcome any inherent incompatibilities between the electromagnetic properties of the modulating signal and those of the transmission medium. Of primary importance in this respect is the spectral distribution of power in the modulating signal relative to the passband of the medium. Modulation provides the means for shifting the power of the modulating signal to a part of the frequency spectrum where the medium's transmission characteristics, such as its attenuation, interference, and noise level, are very favorable.

Two forms of modulation are generally distinguished, although they have many properties in common: If the modulating signal's parameter (amplitude, frequency or phase) varies continuously with time, it is said to be an analog signal and the modulation is referred to as analog. In the case where the modulating signal may vary its parameters only between a finite number of values and the change may occur only at discrete moments in time, the modulating signal is said to be a digital signal and the modulation is referred to as digital.

In analog modulation systems, varying the frequency or phase of the carrier of the passband signal results in frequency modulation (FM) or phase modulation (PM), respectively. Since the frequency of a sine wave expressed in radians per second equals the derivative of its phase, frequency modulation and phase modulation are sometimes subsumed under the general term “angle modulation”. Angle modulation is way of modulating a sinusoidal carrier wave in which the angle and related instantaneous frequency of the carrier wave is varied according to the baseband signal. In the angle modulation, the amplitude of the carrier wave is maintained generally constant but there are a different types modulations and modulated signals in which angle and amplitude of the carrier wave are varied at the same time.

If the modulating signal is digital, the baseband modulation is termed amplitude-shift keying (ASK), frequency-shift keying (FSK), or phase-shift keying (PSK), since in this case the discrete parameters of the digital signal can be said to shift the parameter of the carrier signal between a finite number of discrete values of instantaneous frequency or instantaneous frequency and amplitude (I-Q points) as multiple phase-shift keying (MPSK, QPSK or QAM).

Typical example of single-stage digital tuning process based on variable passband decimating filter is described in U.S. Pat. No. 6,631,256 to Suominen. The present invention utilizes at least double stage adaptive filtering process to reach benefits of additional narrow sub-bandwidth and adaptive narrowband band-pass filtering.

It is therefore an object of the present invention to provide high quality and cost-effective, active, multi-stage adaptive filtering by utilizing important information about current value of instantaneous frequency, which is achieved by conventional demodulation and modulation processes in order to significantly improve signal-to-noise ration (SNR) regarding to well-known single-stage, passive, pass-band filtering based on bandpass matched filters.

### SUMMARY OF THE INVENTION

The present invention relates to multi-stage band-pass filtering of angle modulated signals by utilizing any conventional demodulation and modulation calculation techniques for calculate and estimate current value of instantaneous frequency, which is served as central filtering frequency for additional stage of narrower sub-bandwidth filtering. Since the instantaneous frequency varies with time within boundaries of the whole available spectrum of modulated signal, therefore it is required fast and real-time central filtering frequency adjusting and tuning of appropriate adaptive sub-bandwidth band-pass filter to follow after the said varied value of the instantaneous frequency or alternatively, it is required utilizing multi-filter approach, by means of choosing the right filter having the best SNR in order to detect and estimate the current value of the instantaneous frequency within one from other sub-band-pass filters having constant and predetermined central filtering frequency and narrowed bandwidth and thus, it allows significant canceling the spread spectrum noise influence from other frequencies outside the desired instantaneous frequency within total bandwidth boundaries of tuning range, in which the current value of instantaneous frequency of modulated signal is varied.

Since the current instantaneous frequency always utilizes very narrower frequency bandwidth within all available total bandwidth of baseband or passband angle modulated signal, therefore, it allows powerful noise canceling from undesirable spectral noise from the rest passband frequencies by applying appropriate and fast adaptive filtering in addition to conventional passband band-pass filtering techniques.

The proposed method of active adaptive filtering of instantaneous frequency within total modulated signal may be applied, in additional to well-known FM broadcasting, to other modern modulation technics, such as OFDM-PM or OFDM-FM instead of OFDM with usual RF carrier conversion. The other possible application of the proposed method is to improve performance of Phase-locked loop (PLL) schemes based on improving of filtering quality or quality of current frequency estimation calculation of phase-locked frequency which is varied and changed due to influence of channel noise or doppler effect, for example.

The proposed method was successfully simulated based on Matlab simulation tool and obtained outstanding performances. SNR improvement about of 2, 5 . . . 6 dB regarding to optimal Matlab's FM demodulation function “fmdemod( )” was achieved for simplified implementation based on dividing the whole passband signal bandwidth to four adjoined sub-bandpass filters and choosing the right matched filter according to current estimation of instantaneous frequency which was performed by the demodulation process. For comparing, the SNR improvement more than 0.5 . . . 1 dB in demodulator is known as very significant achievement.

These and other aspects, objects, and advantages of the invention will become apparent to those skilled in the art from the following detailed description in conjunction with the accompanying drawings.

### BRIEF DESCRIPTION OF THE DRAWINGS

FIG. 1 is a functional block diagram representation an embodiment of functional configuration of a multi-stage adaptive filtering process according to the present invention.

FIG. 2 is a spectrum diagram view of the bandwidth utilization and adaptive sub-bandwidth filtering of estimated instantaneous frequency according to the present invention.

### DETAILED DESCRIPTION OF PREFERRED EMBODIMENTS OF THE INVENTION

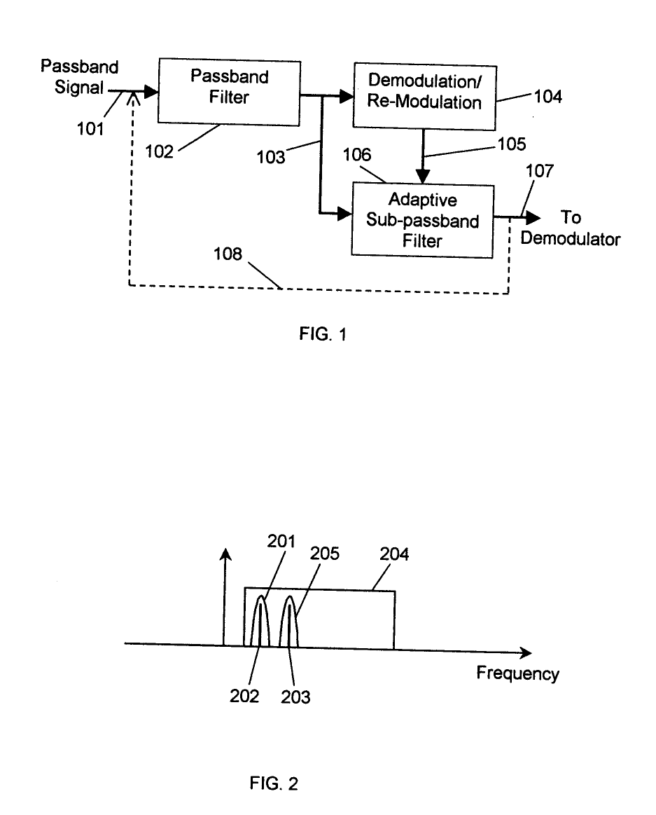

FIG. 1 depicts an embodiment of the present invention in general diagrammatic and functional form for ease of initial understanding. Shown in FIG. 1 is passband matched filter 102 which receives whole available passband signal 101 with full available passband bandwidth spectrum 204 of angle modulated signal which having only one specific value of instantaneous frequency in each time moment within full range of instantaneous frequency variation in boundaries of the said passband bandwidth spectrum range.

The received passband signal 101, having channel noise at the frequencies out of available passband spectrum 204, is filtered by passband matched filter 102 and, thereafter, is converted by the appropriate functional module 104 to initial modulating baseband signal by demodulation and thereafter re-modulation processes using direct correlation between modulating passband and modulated baseband signals in order to obtain the estimated value 105 of desired instantaneous frequency, based on the said direct correlation between specific value of modulating signal and specific value of modulated instantaneous frequency. The aim of the module 104 is real-time and continuous calculation of the current estimated value 105, 202 and 203 of instantaneous frequency that varies according to varies of modulating signal and the said estimated value 105 manages, moves and choose the appropriate central filtering frequency 202, 203 of narrowed sub-filter 106, 201 and 205, respectively, in order to pass frequency spectrum 201, 205 near the said calculated instantaneous frequency 202, 203 respectively, and stop signals from the rest available frequency spectrum 204. In other words, the value 105 always could be equal and follows after variation of current calculated estimation of instantaneous frequency 202, 203 in the received modulated signal and it allows to choose adaptively the appropriate narrowed adaptive real-time sub-passband filter 201, 205 respectively, to pass the narrowed spectrum which closes to instantaneous frequency 201, 205 and reject other noise signals from other frequencies within whole available spectrum bandwidth 204 of angle modulated signal and thus significantly improve total signal-to-noise ration in the output filtered signal 107.

The module 104 may obtain the said estimated value 105 of instantaneous frequency 202 or 203 by applying any available demodulation method to calculate the current value of modulating signal and thereafter to calculate appropriate estimated value of modulated signal by means of re-modulation process which always allows to find out the any appropriate output value of modulated signal according to any input value of modulating signal.

The estimated value 105, of current instantaneous frequency 202 or 203, which calculated by the said functional module 104, is intended to be current real-time adaptive central filtering frequency 202 and 203 of the appropriate adaptive narrow sub-passband filter 106 having narrowed pass-band bandwidth 201 or 205, regarding to whole passband bandwidth 103 and 204, in order to find and pass out only current instantaneous frequency signal 202 or 203, respectively, from total available passband bandwidth 103 of modulated signal 204. Since the instantaneous frequency 105 of passband signal 204 varies in the time (202, 203) within available passband spectrum range 204, therefore the said adaptive sub-passband filter 106 varies its central filtering frequency 202 or 203 and its corresponded narrowband band-pass filtering bandwidth 201 or 205, respectively, in the same way in order to be equal to the estimated value 202 or 203 of the current instantaneous frequency 105 to produce out 107 cleared and filtered from passband noise the passband signal. The estimated value 105, of instantaneous frequency and corresponding value of modulating signal, which allows to choose the central frequency of sub-bandpass filter or, the one appropriate filter from the set of spectrally adjoining sub-bandpass filters, the value 105 may be directly associated by pre-calculated look-up table to desired voltage range of managing signal which performs the said choose of appropriate matched sub-bandpass filter or central frequency of adaptive sub-bandpass filter.

The clear output passband signal 107 with improved SNR may be additionally filtered once more to reach more clear passband signal with better SNR by inserting itself again 108 to the same filtering scheme as seen in FIG. 1 or may be passed as new passband signal 101 (204) to the next stage of filtering iteration 108 in order to repeat the above iterative multi-stage filtering process. The output filtered passband signal 107 may be moved to appropriate signal demodulator to final demodulation according to applied demodulation scheme.

Instead of terms “passband” signal 101, “passband” filter 102 and “sub-passband” filter 106 may be sometimes also applied terms “baseband” signal 101 “baseband” filter 102 and “sub-baseband” filter 106, respectively, in the case of applying this filtering scheme as described in the FIG. 1 to filtering aforesaid angle modulated baseband signals, where the baseband signal is converted after demodulation to initial digital pulse modulating signal, for example. In the first case, the “passband” signal is converted by demodulation process to “baseband” signal and in the second case, the “baseband” signal is converted by demodulator to sequence of digital pulses. Instead of term “passband” filter 101 and sub-passband filter 106 may be applied term “bandpass” and “sub-passband” filters respectively, and sometimes highpass and lowpass filters for a different types of band-limited passband and baseband angle modulated signals.

FIG. 2 shows the embodiment of multi-stage adaptive narrow bandwidth pass-band filtering system depicted in FIG. 1 of the present invention in general spectrum diagram view. Passband signal 101 having total bandwidth 204 is filtered by matched passband filter 102 which having the passband spectrum bandwidth 204. After precision calculation of estimated value 105 of current instantaneous frequency 202 or 203, the sub-passband adaptive filter 106 which having narrower bandwidth 201 and 205 is filtering the said current values 202 or 203 of the instantaneous frequency signal, respectively and thus, the rest of passband noise is significantly canceled within output passband signal 107.

The proposed method and system can be practically implemented in the different ways, for example, as digital implementation based on Hardware Description Language (HDL) for FPDA and ASIC, analog VLSI implementation or Software implementation based on assembler code for digital signal processors (DSP).

Although the invention has been described herein with specific reference to presently preferred embodiments thereof, it will be appreciated by those skilled in the art that various additions, modifications, deletions and alterations may be made to such preferred embodiments thereof, it will be appreciated by those skilled in the art that various additions, modifications, deletions and alterations may be made to such preferred embodiments without departing from the spirit and scope of the invention. Accordingly, it is intended that all reasonably foreseeable additions, deletions, alterations and modifications be included within the scope of the invention as defined by the appended claims.

What is claimed is:

1. A method for iterative multi-stage adaptive narrowband band-pass filtering of angle modulated passband and baseband signals, which are created by any form of modulation of instantaneous frequency within some bandwidth range of modulated signal, by means of calculation and estimation of current value of the said instantaneous frequency by using demodulation and reverse-modulation calculation process to calculate the said estimated value of the instantaneous frequency, and applying narrower sub-bandwidth adaptive matched band-pass filter, which follows in real-time after the said estimated instantaneous frequency, and which having appropriate narrow sub-bandpass bandwidth to pass the said current instantaneous frequency signal and to stop signals from other frequencies, where the said current value of the instantaneous frequency is the central filtering frequency of the said sub-bandwidth bandpass filter, comprising the following means and steps:
applying calculation of current estimation of the said current value of instantaneous frequency by means of the said demodulation to calculate current estimated value of modulating signal and the said reverse-modulation calculation process to calculate estimated value of the said current value of the instantaneous frequency based on known relation between modulating and modulated signals;
applying the said value of the said current instantaneous frequency as said central filtering frequency for the said adaptive band-pass filter which having narrowed sub-bandpass bandwidth regarding to total bandwidth of the said angle modulated signal;
applying the said adaptive sub-bandwidth band-pass filter having the said narrowed bandwidth regarding to total bandwidth of variation of the said instantaneous frequency for filtering the said modulated signal which includes the said instantaneous frequency signal within whole received modulated signal, which having noise outside the said instantaneous frequency, by means of the said real-time adaptive, matched and appropriate varying its central filtering frequency according to varying of calculated and estimated current value of the said instantaneous frequency.

2. A system, a device and a circuit are utilized a method is claimed in claim 1, including the following functional means and elements:
a said current instantaneous frequency calculation based on the said demodulation and the said reverse modulation calculation techniques;
a said adaptive sub-bandwidth narrow band-pass filter, which having narrowed bandwidth regarding to total signal bandwidth, and which having said central filtering frequency is equal and following to the said current calculated instantaneous frequency in order to real-time matched filtering only said current value of the said modulated instantaneous frequency.
